(19) United States
(12) Patent Application Publication
(10) Pub. No.: US 2017/0217830 A1
(43) Pub. Date: Aug. 3, 2017

(54) PROCESS FOR PRODUCING WAVELENGTH CONVERSION MEMBER, AND WAVELENGTH CONVERSION MEMBER

(71) Applicant: NIPPON ELECTRIC GLASS CO., LTD., Otsu-shi, Shiga (JP)

(72) Inventors: Masaaki KADOMI, Otsu-shi (JP); Takashi NISHIMIYA, Otsu-shi (JP); Hideki ASANO, Otsu-shi (JP)

(21) Appl. No.: 15/328,171

(22) PCT Filed: Aug. 18, 2015
(86) PCT No.: PCT/JP2015/073108

§ 371 Date: Jan. 23, 2017

(30) Foreign Application Priority Data
Sep. 1, 2014 (JP) 2014-176788

(51) Int. Cl. C03C 14/00; C09K 11/88; F21V 9/16; C03C 3/16; C03B 19/06; C09K 11/02; C03C 4/12

(52) U.S. Cl. CPC C03C 14/006; C09K 11/025; C09K 11/883; C03C 4/12; C03C 3/16; C03B 19/06; F21V 9/16; C03C 2204/00; C03C 2214/05; B82Y 40/00

(57) ABSTRACT

Provided is a process for producing a wavelength conversion member which can suppress the reaction between inorganic nanophosphor particles and glass to suppress the deterioration of the inorganic nanophosphor particles, and the wavelength conversion member. The process for producing a wavelength conversion member includes the steps of: preparing inorganic nanophosphor particles 1 with an organic protective film formed on respective surfaces thereof; and mixing the inorganic nanophosphor particles 1 with glass powder and firing a resultant mixture in a temperature range where the organic protective films remain as retained films 3.

### TECHNICAL FIELD

The present invention relates to processes for producing wavelength conversion members, and wavelength conversion members.

### BACKGROUND ART

Recently, studies have been made on light emitting devices in which an excitation light source, such as a light emitting diode (LED) or a semiconductor laser diode (LD), is used, excitation light generated from the excitation light source is applied to a phosphor, and fluorescence thus generated is used as illuminating light. Furthermore, studies have also been made on the use, as a phosphor, of inorganic nanophosphor particles called semiconductor nanoparticles or quantum dots. Inorganic nanophosphor particles can be controlled in fluorescence wavelength by changing their diameter and have high luminous efficiency.

However, inorganic nanophosphor particles have the property of being easily deteriorated by contact with moisture or oxygen in the air. Therefore, inorganic nanophosphor particles need to be used in a sealed state to avoid contact with the external environment. If resin is used as the sealing material, part of energy during wavelength conversion of excitation light using a phosphor is converted to heat, which presents the problem that the resin is discolored by the heat. In addition, resin is poor in water resistance and permeable to moisture, which presents the problem that the phosphor is likely to deteriorate.

Patent Literature 1 proposes a wavelength conversion member in which glass is used as a sealing material in place of resin. Specifically, Patent Literature 1 proposes a wavelength conversion member in which glass is used as a sealing material by firing a mixture containing inorganic nanophosphor particles and glass powder.

### CITATION LIST

### Patent Literature

[PTL 1]

JP-A-2012-87162

### SUMMARY OF INVENTION

### Technical Problem

However, in the case where the mixture containing inorganic nanophosphor particles and glass powder is fired to seal the inorganic nanophosphor particles in glass, there arises the problem that the inorganic nanophosphor particles react with the glass to deteriorate.

An object of the present invention is to provide a process for producing a wavelength conversion member which can suppress the reaction between inorganic nanophosphor particles and glass to suppress the deterioration of the inorganic nanophosphor particles, and to provide the wavelength conversion member.

### Solution to Problem

A process for producing a wavelength conversion member according to the present invention includes the steps of: preparing inorganic nanophosphor particles with an organic protective film formed on respective surfaces thereof; and mixing the inorganic nanophosphor particles with glass powder and firing a resultant mixture in a temperature range where the organic protective film is retained.

An example of the temperature range that can be cited is 500° C. or less.

The step of mixing the inorganic nanophosphor particles with glass powder may include the step of depositing the inorganic nanophosphor particles on particle surfaces of the glass powder. In this case, the inorganic nanophosphor particles can be deposited on the particle surfaces of the glass powder, for example, by making a liquid containing the inorganic nanophosphor particles dispersed in a dispersion medium into contact with the glass powder and then removing the dispersion medium in the liquid.

In the present invention, the glass powder is preferably at least one selected from the group consisting of SnO—P₂O₅-based glasses, SnO—P₂O₅—B₂O₃-based glasses, SnO—P₂O₅—F-based glasses, and Bi₂O₃-based glasses.

A wavelength conversion member according to the present invention includes inorganic nanophosphor particles, a glass matrix containing the inorganic nanophosphor particles dispersed therein, and retained films made of organic protective films that are provided between the inorganic nanophosphor particles and the glass matrix and retained even after having undergone firing.

### Advantageous Effects of Invention

According to the present invention, the reaction between inorganic nanophosphor particles and glass can be suppressed to suppress the deterioration of the inorganic nanophosphor particles.

### BRIEF DESCRIPTION OF DRAWINGS

FIG. 1 is a schematic cross-sectional view showing a wavelength conversion member according to one embodiment of the present invention.

FIG. 2 is a schematic cross-sectional view showing an inorganic nanophosphor particle with an organic protective film formed on the surface thereof.

FIG. 3 is a schematic cross-sectional view showing a glass powder particle on the surface of which inorganic nanophosphor particles with an organic protective film formed on their respective surfaces are deposited.

FIG. 4 is a schematic cross-sectional view showing a wavelength conversion member according to a comparative example.

### DESCRIPTION OF EMBODIMENTS

Hereinafter, a description will be given of a preferred embodiment. However, the following embodiment is merely illustrative and the present invention is not limited to the following embodiment. Throughout the drawings, members having substantially the same functions may be referred to by the same reference characters.

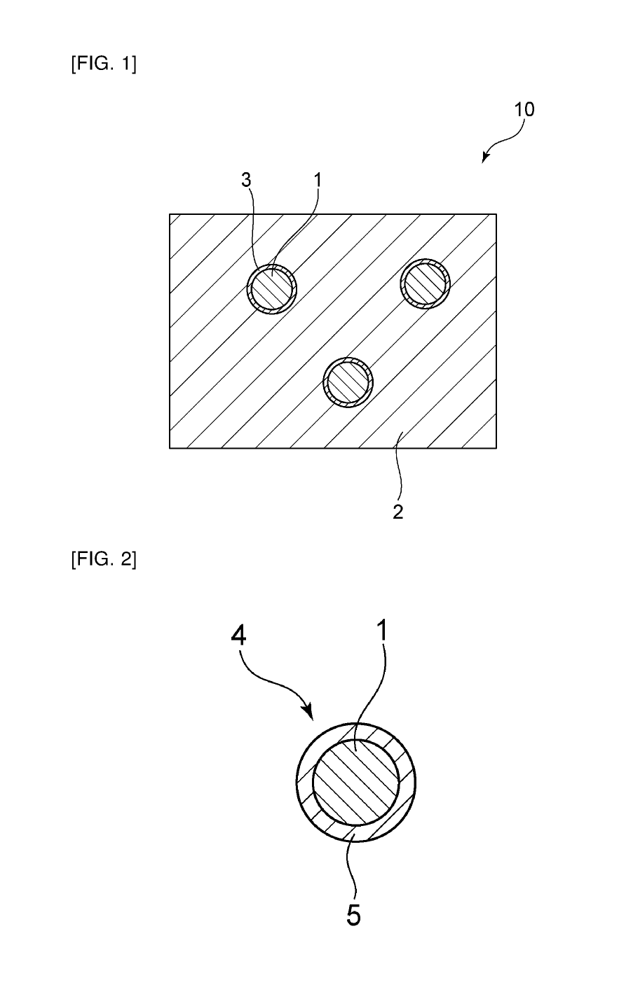

FIG. 1 is a schematic cross-sectional view showing a wavelength conversion member according to one embodiment of the present invention. As shown in FIG. 1, a wavelength conversion member 10 according to this embodiment includes inorganic nanophosphor particles 1, a glass matrix 2 containing the inorganic nanophosphor particles 1 dispersed therein, and retained films 3 provided between each inorganic nanophosphor particle 1 and the glass matrix 2.

A description will be given below of a process for producing the wavelength conversion member 10 according to this embodiment.

FIG. 2 is a schematic cross-sectional view showing an inorganic nanophosphor particle with an organic protective film formed on the surface thereof. A protective film-deposited phosphor particle 4 shown in FIG. 2 is made up by forming an organic protective film 5 on the surface of the inorganic nanophosphor particle 1. The organic protective film 5 becomes a retained film 3 shown in FIG. 1 after undergoing firing. In the production process according to this embodiment, first, protective film-deposited phosphor particles 4 are prepared.

As the inorganic nanophosphor particles 1, phosphor particles made of inorganic crystals having a particle size of below 1 μm can be used. Examples of such inorganic nanophosphor particles that can be used include those generally called semiconductor nanoparticles or quantum dots. Examples of the semiconductor of such inorganic nanophosphor particles include group II-VI compounds and group III-V compounds.

Examples of the group II-VI compounds that can be cited include CdS, CdSe, CdTe, ZnS, ZnSe, and ZnTe. Examples of the group III-V compounds that can be cited include InP, GaN, GaAs, GaP, AlN, AlP, AlSb, InN, InAs, and InSb. At least one or a composite of two or more selected from the above compounds can be used as the inorganic nanophosphor particles in the present invention. Examples of the composite that can be cited include those having a core-shell structure, for example, a composite having a core-shell structure in which the surfaces of CdSe particles are coated with ZnS.

The particle size of the inorganic nanophosphor particles 1 is appropriately selected within the range of, for example, 100 nm or less, preferably 50 nm or less, particularly preferably 1 to 30 nm, more preferably 1 to 15 nm, or still more preferably 1.5 to 12 nm.

Examples of the organic protective film 5 that can be cited include polymers and organic ligands for increasing the dispersibility of the inorganic nanophosphor particles 1 in the dispersion medium. Specifically, examples of the polymers and organic ligands include organic molecules containing an aliphatic hydrocarbon group having a straight-chain or branched structure of 2 to 30 carbon atoms, preferably 4 to 20 carbon atoms, and more preferably 6 to 18 carbon atoms. The polymers and organic ligands preferably have a functional group to be coordinated to the inorganic nanophosphor particle 1. Examples of such a functional group that can be cited include a carboxyl group, an amino group, an amide group, a nitrile group, a hydroxyl group, an ether group, a carbonyl group, a sulphonyl group, a phosphonyl group, and a mercapto group. Furthermore, in addition to a functional group to be coordinated to the inorganic nanophosphor particle 1, an additional functional group may be contained at an intermediate point or the end of the hydrocarbon group. Examples of such a functional group that can be cited include a nitrile group, a carboxyl group, a halogen group, a halogenated alkyl group, an amino group, an aromatic hydrocarbon group, an alkoxyl group, and a carbon-carbon double bond.

The amount of organic protective films 5 deposited on the inorganic nanophosphor particles 1 is, in unit of number of polymers or organic ligands per inorganic nanophosphor particle 1, preferably 2 to 500, more preferably 10 to 400, and still more preferably 20 to 300. If the amount of organic protective films 5 deposited is too small, the inorganic nanophosphor particles 1 are likely to aggregate. On the other hand, if the amount of organic protective films 5 deposited is too large, the luminescence intensity of the inorganic nanophosphor particles 1 is likely to decrease.

The organic protective films 5 can be formed, for example, by depositing organic protective films 5 on the surfaces of inorganic nanophosphor particles 1 with the inorganic nanophosphor particles 1 dispersed in an organic solvent, such as toluene.

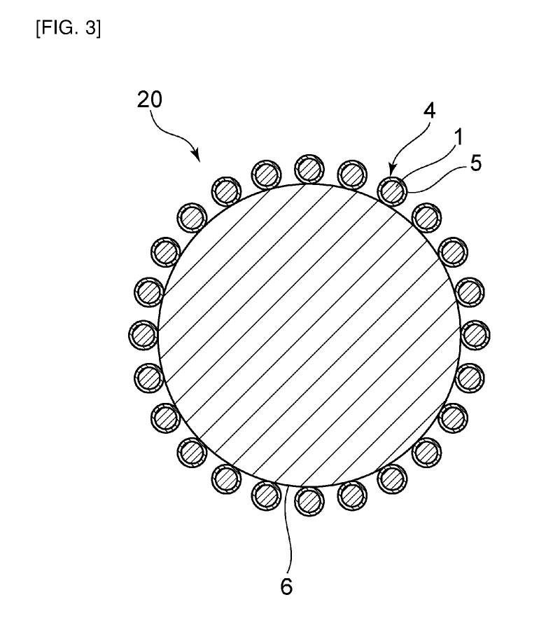

Next, in the production process according to this embodiment, the inorganic nanophosphor particles 1 with an organic protective films 5 formed thereon, i.e., the protective film-deposited phosphor particles 4, and glass powder are mixed. FIG. 3 is a schematic cross-sectional view showing a glass powder particle 6 on the surface of which protective film-deposited phosphor particles 4 are deposited. In this embodiment, phosphor-deposited glass powder particles 20 are prepared in which protective film-deposited phosphor particles 4 are uniformly dispersed and deposited on the surface of each glass powder particle 6. By firing the phosphor-deposited glass powder 20, a wavelength conversion member can be produced in which inorganic nanophosphor particles 1 are uniformly dispersed in a glass matrix. However, the present invention is not limited to this.

The phosphor-deposited glass powder 20 can be prepared, for example, by making protective film-deposited phosphor particles 4 into contact with glass powder 6 in a liquid containing the protective film-deposited phosphor particles 4 dispersed in a dispersion medium and then removing the dispersion medium in the liquid. Examples of the method for making the protective film-deposited phosphor particles 4 into contact with the glass powder 6 include the method of adding the glass powder 6 into the liquid containing the protective film-deposited phosphor particles 4 dispersed therein and the method of impregnating a preform of the glass powder 6 with the liquid containing the protective film-deposited phosphor particles 4 dispersed therein.

From the viewpoint of decreasing the firing temperature, the glass powder preferably has a low softening point. Specifically, the preferred glass powder to be used is one made of a glass having a softening point of preferably 500° C. or less, more preferably 400° C. or less, and still more preferably 350° C. or less. Examples of such glass powder that can be cited include SnO—P₂O₅-based glasses, SnO—P₂O₅—B₂O₃-based glasses, SnO—P₂O₅—F-based glasses, and Bi₂O₃-based glasses.

The SnO—P₂O₅-based glasses contain, as a glass composition in percent by mole, preferably 40 to 85% SnO and 15 to 60% P₂O₅, and particularly preferably 60 to 80% SnO and 20 to 40% P₂O₅.

The SnO—P₂O₅—B₂O₃-based glasses contain, as a glass composition in percent by mole, preferably 35 to 80% SnO, 5 to 40% P₂O₅, and 1 to 30% B₂O₃.

The SnO—P₂O₅-based glasses and the SnO—P₂O₅—B₂O₃-based glasses may further contain, as optional components, 0 to 10% Al₂O₃, 0 to 10% SiO₂, 0 to 10% Li₂O, 0 to 10% Na₂O, 0 to 10% K₂O, 0 to 10% MgO, 0 to 10% CaO, 0 to 10% SrO, and 0 to 10% BaO. They may further contain, in addition to the above components, a component for improving weatherability, such as Ta₂O₅, TiO₂, Nb₂O₅, Gd₂O₃ or La₂O₃, and a component for stabilizing the glass, such as ZnO.

The SnO—P₂O₅—F-based glasses preferably contain, in percent by cation, 10 to 70% P⁵⁺ and 10 to 90% Sn²⁺ and, in percent by anion, 30 to 100% O²⁻ and 0 to 70% F⁻. In order to improve weatherability, it may further contain B³⁺, Si⁴⁺, Al³⁺, Zn²⁺ or Ti⁴⁺ in a total content of 0 to 50%.

The Bi₂O₃-based glasses preferably contains, as a glass composition in percent by mass, 10 to 90% Bi₂O₃ and 10 to 30% B₂O₃. It may further contain, as glass-forming components, SiO₂, Al₂O₃, B₂O₃, and P₂O₅, each in a content of 0 to 30%.

From the viewpoint of lowering the softening point of the SnO—P₂O₅-based glasses and SnO—P₂O₅—B₂O₃-based glasses and stabilizing the glass, the molar ratio between SnO and P₂O₅ (SnO/P₂O₅) is preferably in the range of 0.9 to 16, more preferably in the range of 1.5 to 10, and still more preferably in the range of 2 to 5. If the molar ratio (SnO/P₂O₅) is too small, this makes firing at low temperatures difficult, so that the inorganic nanophosphor particles may be likely to deteriorate during sintering. In addition, the weatherability may be excessively low. On the other hand, if the molar ratio (SnO/P₂O₅) is too high, the glass may be likely to devitrify and have excessively low transmittance.

The average particle size D50 of the glass powder is preferably 0.1 to 100 μm and particularly preferably 1 to 50 μm. If the average particle size D50 of the glass powder is too small, bubbles are likely to form during sintering. Thus, the mechanical strength of the resultant wavelength conversion member may be decreased. Furthermore, owing to bubbles formed in the wavelength conversion member, light-scattering loss may be increased to decrease the luminous efficiency. On the other hand, if the average particle size D50 of the glass powder is too large, the inorganic nanophosphor particles are less likely to be uniformly dispersed in the glass matrix, so that the luminous efficiency of the resultant wavelength conversion member may be low. The average particle size D50 of the glass powder can be measured with a laser diffraction particle size distribution measurement device.

No particular limitation is placed on the dispersion medium to be used so long as it can disperse the inorganic nanophosphor particles therein. Generally, non-polar solvents having suitable volatility, such as hexane and octane, can be preferably used. However, the dispersion mediums to be used are not limited to the above and may be polar solvents having suitable volatility.

Next, in the production process according to this embodiment, a mixture of the protective film-deposited phosphor particles 4 and the glass powder 6 is fired in a temperature range where the organic protective films 5 remain as retained films 3. In this embodiment, the phosphor-deposited glass powder 20 is fired in a temperature range where the organic protective films 5 remain as retained films 3. Thus, as shown in FIG. 1, firing can be performed in a state where the retained films 3 are present on the surfaces of the inorganic nanophosphor particles 1, so that the reaction between the inorganic nanophosphor particles 1 and the glass matrix 2 can be suppressed. Therefore, the deterioration of the inorganic nanophosphor particles 1 can be suppressed.

The firing temperature is preferably not higher than 500° C., more preferably not higher than 400° C., and still more preferably not higher than 350° C. By lowering the firing temperature, the reaction between the inorganic nanophosphor particles 1 and the glass matrix 2 can be further suppressed. On the other hand, in order to densely sinter the glass powder 6, the firing temperature is preferably not lower than 150° C.

The atmosphere during firing is preferably a vacuum atmosphere or an inert atmosphere using nitrogen or argon. Thus, the deterioration and coloration of the glass powder 6 during sintering can be suppressed. Particularly in a vacuum atmosphere, the formation of bubbles in the wavelength conversion member 10 can be suppressed.

In the above manner, the wavelength conversion member 10 shown in FIG. 1 can be produced. The presence of the retained films 3 on the surfaces of the inorganic nanophosphor particles 1 can be confirmed in the following manner. It can be checked by grinding the wavelength conversion member, heating the ground product to 600° C. with flowing of He gas, and determining whether or not CO₂ gas is detected in a resultant volatilized gas. If CO₂ gas is detected, the retained films 3 are present on the surfaces of the inorganic nanophosphor particles 1.

### EXAMPLES

<Production of Wavelength Conversion Member>

### Example 1

As inorganic nanophosphor particles, those having a core-shell structure of CdSe (core)/ZnS (shell) and a particle size of 3 nm (green) and those having the same core-shell structure and a particle size of 6 nm (red) were used. On the surfaces of the inorganic nanophosphor particles, about 50 organic molecules containing a aliphatic hydrocarbon group of 10 carbon atoms were deposited as an organic protective film per inorganic nanophosphor particle. A preform (compressed powder body) of glass powder (having a composition (mass ratio) of 72% SnO and 28% P₂O₅, an average particle size D50 of 4 μm, and a softening point of 290° C.) was impregnated with a dispersion liquid in which the above inorganic nanophosphor particles were contained 1% by mass in octane as a dispersion medium, and the dispersion medium was then removed, thus preparing a preform of glass powder having inorganic nanophosphor particles deposited thereon. The mass ratio between the glass powder and the inorganic nanophosphor particles ((glass powder):(inorganic nanophosphor particles)) is 50:1.

The preform of glass powder having inorganic nanophosphor particles deposited thereon was fired at a firing temperature of 300° C. in a vacuum atmosphere, thus producing a wavelength conversion member.

### Comparative Example 1

A wavelength conversion member was produced in the same manner as in Example 1 except that the firing temperature was 550° C.

<Evaluation of Luminescence Intensity>

While in Example 1 the resultant wavelength conversion member had the same color as the inorganic nanophosphor particle dispersion liquid, the wavelength conversion member of the comparative example had lost the color of the inorganic nanophosphor particle dispersion liquid by firing. When excitation light (having a wavelength of 460 nm) was applied to each wavelength conversion member, luminescence was observed in the wavelength conversion member of Example 1 but not observed in the wavelength conversion member of Comparative Example 1. As seen from this, in Example 1, the deterioration of the inorganic nanophosphor particles due to firing could be suppressed.

<Confirmation of Retained Film>

The wavelength conversion members obtained in Example 1 and Comparative Example 1 were ground, the ground products were heated to 600° C. with flowing of He gas, and their resultant volatilized gases were analyzed with a quadrupole mass spectrometer (M-101QA-TDM manufactured by CANON ANELVA CORPORATION).

CO₂ gas was detected in Example 1, but not detected in Comparative Example 1. Therefore, it can be seen that retained films were present in Example 1 but not present in Comparative Example 1.

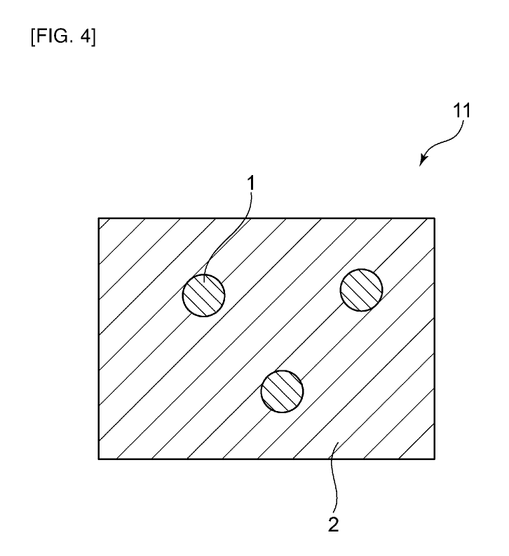

It can be considered that as shown in FIG. 4, in the wavelength conversion member 11 of Comparative Example 1, no retained film was present, the inorganic nanophosphor particles 1 came into direct contact with the glass matrix 2, and the reaction between the inorganic nanophosphor particles 1 and the glass matrix 2 during the production steps was not suppressed.

In contrast, it can be seen that as shown in FIG. 1, by conducting firing to allow the retained films 3 to be present on the surfaces of the inorganic nanophosphor particles 1 in accordance with the present invention, the reaction between the inorganic nanophosphor particles 1 and the glass matrix 2 during the production steps can be suppressed to suppress the deterioration of the inorganic nanophosphor particles 1.

### REFERENCE SIGNS LIST

1 . . . inorganic nanophosphor particle

2 . . . glass matrix

3 . . . retained film

4 . . . protective film-deposited phosphor particle

5 . . . organic protective film

6 . . . glass powder

10 . . . wavelength conversion member

11 . . . wavelength conversion member

20 . . . phosphor-deposited glass powder

1. A process for producing a wavelength conversion member, the process comprising the steps of:
preparing inorganic nanophosphor particles with an organic protective film formed on respective surfaces thereof; and
mixing the inorganic nanophosphor particles with glass powder and firing a resultant mixture in a temperature range where the organic protective film is retained.

2. The process for producing a wavelength conversion member according to claim 1, wherein the temperature range is 500° C. or less.

3. The process for producing a wavelength conversion member according to claim 1, wherein the step of mixing the inorganic nanophosphor particles with glass powder comprises the step of depositing the inorganic nanophosphor particles on particle surfaces of the glass powder.

4. The process for producing a wavelength conversion member according to claim 3, wherein the inorganic nanophosphor particles are deposited on the particle surfaces of the glass powder by making a liquid containing the inorganic nanophosphor particles dispersed in a dispersion medium into contact with the glass powder and then removing the dispersion medium in the liquid.

5. The process for producing a wavelength conversion member according to claim 1, wherein the glass powder is at least one selected from the group consisting of SnO—P₂O₅-based glasses, SnO—P₂O₅—B₂O₃-based glasses, SnO—P₂O₅—F-based glasses, and Bi₂O₃-based glasses.

6. A wavelength conversion member comprising:
inorganic nanophosphor particles;
a glass matrix containing the inorganic nanophosphor particles dispersed therein; and
retained films made of organic protective films that are provided between the inorganic nanophosphor particles and the glass matrix and retained even after having undergone firing.
